(19) United States
(12) Patent Application Publication
(10) Pub. No.: US 2025/0008174 A1
(43) Pub. Date: Jan. 2, 2025

(54) METHOD FOR TRACKING DISTRIBUTION OF A SHARED DIGITAL MEDIA FILE

(71) Applicant: BLACKBIRD PLC, London (GB)

(72) Inventor: Stephen STREATER, London (GB)

(21) Appl. No.: 18/705,568

(22) PCT Filed: Oct. 31, 2022
(86) PCT No.: PCT/GB2022/052749

§ 371 Date: Apr. 28, 2024

(30) Foreign Application Priority Data
Oct. 29, 2021 (GB) 2115594.0

(51) Int. Cl. H04N 21/24; H04N 21/239; H04N 21/472; H04N 21/858

(52) U.S. Cl. CPC H04N 21/2407; H04N 21/2393; H04N 21/47217; H04N 21/8586

(57) ABSTRACT

A computer-implemented method for tracking distribution of a shared digital media file, comprising; (i) making a digital media file available at a server to a plurality of users, each user having a respective registered account at the server; (ii) receiving from a first user a request to share the digital media file with a second user; (iii) sending a first link from the server to the second user, for accessing the digital media file, the first link including data uniquely identifying the digital media file, the first user and the second user; (iv) the server receiving a selection of the first link by the second user; (v) the server sending or playing the digital media file to the second user; (vi) the server recording that the digital media file was shared by the first user with the second user, to track distribution of the digital media file.

### BACKGROUND OF THE INVENTION

### 1. Field of the Invention

The field of the invention relates to online sharing of digital media files, for example digital video files, digital image files and/or digital audio files.

### 2. Technical Background

The internet has created a rapacious demand for content, and increasingly video content.

Making high quality video has traditionally been a skilled professional job, where good quality content has required considerable technique and experience. As a result, much of the professional content viewed from films and television to sports highlights and video clips on social media has been edited by dedicated professionals using sophisticated workflows, often with significant finance behind them.

There is a burgeoning alternative to professionally produced video, dubbed the Creator Economy. This includes creative people who would like to express themselves and monetize their media content, particularly in video form. From now on in this document, the word “media” will mean any time-changing content, including video. The estimated >50 million (e.g. video) creators cover a vast range of skills: e.g. Pilates teachers and football coaches, writers and professors, painters and chefs, Go players and political video bloggers, and so on.

These (e.g. video) creators can use media content to monetize their skill, but while they may be able to make excellent content, marketing and monetizing may not be their main skill. Without the budgets and skills available to large scale organizations, (e.g. video) creator content may go unseen and unappreciated.

Traditional methods of monetizing (e.g. video) content have some particular drawbacks:
social media sites may direct traffic elsewhere, or censor content, destroying a (e.g. video) creator's income stream. This makes it undesirable to rely on income from social media sites.
Advertising based on the “Attention economy” can have a low per ad/click through from often incidental viewers. Creators (e.g. video creators) cannot easily get more money from those viewers who particularly benefit from content and would be willing to pay much more.
There is little incentive for viewers to re-share and otherwise promote good (e.g. video) content. This means that the viewer acquisition is dependent largely on the (e.g. video) creator, and this can be costly and time consuming.

Examples of the inventions described in this document are designed to help (e.g. video) creators to leverage their viewers to spread their best (e.g. video) content far and wide and to help monetize the (e.g. video) content. Examples of the inventions described in this document allow viewers to act as quasi-distributors who may benefit from sharing and otherwise promoting content, including video content.

### 3. Discussion of Related Art

EP3503497 (A1) and EP3503497 (B1) disclose that a method for authorizing online sharing of content including a digital photograph or video, includes receiving, at an electronic device, the content, identifying an image of a person in the content, identifying authorization conditions associated with the person, identifying an image of an object or audio in the content, based on both the image of the person identified and the image of the object or audio identified, determining if the authorization conditions associated with the person are met, and in response to determining that the authorization conditions are met, providing online access to the digital photograph or video.

WO2017/146931 and EP3420724B1 disclose sharing video footage recorded by audio/video (A/V) recording and communication devices, such as video doorbells and security cameras. When an A/V recording and communication device records video footage of suspicious activity, or even criminal activity, a user viewing the footage may alert his or her neighbors by sharing the video. In various embodiments, the user may share the video with anyone of the user's choosing, including neighbors, friends, and family.

### SUMMARY OF THE INVENTION

According to a first aspect of the invention, there is provided a computer-implemented method for tracking distribution of a shared digital media file, the method including the steps of:
(i) making a digital media file available at a server to a plurality of users, each user of the plurality of users having a respective registered account at the server;
(ii) receiving from a first user having a respective registered account at the server a request to share the digital media file with a second user having a respective registered account at the server;
(iii) sending a first link from the server to the second user, for accessing the digital media file, the first link including data uniquely identifying the digital media file, the first user and the second user;
(iv) the server receiving a selection of the first link by the second user;
(v) the server sending or playing the digital media file to the second user;
(vi) the server recording that the digital media file was shared by the first user with the second user, to track distribution of the digital media file.

An advantage is accurate and rapid collection of distribution volumes for the digital media file. For example the distribution volumes are collected much more accurately and rapidly than by other ways, such as by surveying users. An advantage is accurate and rapid collection of distribution pathways between users for the digital media file. For example the distribution pathways are collected much more accurately and rapidly than by other ways, such as by surveying users. An advantage is energy efficient collection of distribution volumes and distribution pathways for the digital media file. For example, collection of distribution volumes and distribution pathways for the digital media file is more energy efficient than using a blockchain.

The method may be one wherein the first link is a Uniform Resource Locator (URL).

The method may be one wherein the digital media file is a digital video file, or a digital image file or a digital audio file.

The method may be one wherein step (ii) includes using a first user web-based media player including a respective web-based media player user interface, and steps (iii), (iv) and (v) include using a second user web-based media player including a respective web-based media player user interface. An advantage is ease of distribution of the digital media file.

The method may be one wherein the web-based media players provide sharing of the digital media file, without requiring re-rendering. An advantage is rapid distribution of the digital media file. An advantage is low energy distribution of the digital media file

The method may be one wherein the web-based media players permit clipping content prior to sharing clipped content of the digital media file. An advantage is flexible distribution of the digital media file.

The method may be one wherein the web-based media players permit clipping content prior to sharing clipped content of the digital media file, without requiring re-rendering. An advantage is rapid distribution of the digital media file. An advantage is low energy distribution of the digital media file. An advantage is flexible distribution of the digital media file.

The method may be one wherein the web-based media players permit re-clipping content prior to sharing re-clipped content of the digital media file. An advantage is flexible distribution of the digital media file.

The method may be one wherein the web-based media players permit re-clipping content prior to sharing re-clipped content of the digital media file, without requiring re-rendering. An advantage is rapid distribution of the digital media file. An advantage is low energy distribution of the digital media file. An advantage is flexible distribution of the digital media file.

The method may be one wherein the web-based media players user interfaces include buttons selectable to select a monetary value.

The method may be one wherein the web-based media players user interfaces include buttons selectable to select player features such as play the digital media file on a full screen; play the digital media file in a window; change video playback size; change video playback resolution; share the digital media file or share a clip of the digital media file.

The method may be one wherein the web-based media players user interfaces include navigation controls and/or playback controls.

The method may be one wherein the web-based media players user interfaces include buttons for playback at various speeds backwards and forwards, marking start and end points of clips (which may alternatively be achieved via interaction with the video area), single step (or larger jumps) backwards and forwards, jog and shuttle on a navigation bar.

The method may be one wherein the web-based media players user interfaces run in JavaScript in a respective web browser. An advantage is ease of distribution of the digital media file.

The method may be one wherein the web-based media players user interfaces include one or more of: frame accurate access, a choice of playback speeds backwards and forwards, jog and shuttle, a choice of frame size and resolution, including full screen, as well as clipping options, sharing options and payment options.

The method may be one wherein all sharing selected through the web-based media players user interfaces is recorded at the server. An advantage is accurate and rapid collection of distribution volumes for the digital media file. An advantage is accurate and rapid collection of distribution pathways between users for the digital media file. An advantage is energy efficient collection of distribution volumes and distribution pathways for the digital media file.

The method may be one wherein the rights and payment metadata associated with each digital media file are represented by a unique random string attached to the URL.

The method may be one wherein the unique random string is used as a key in a key: value dictionary, where the value contains all the information required to track rights, for example, the ids of the Creator and all subsequent rights holders, the share of income rights purchased by each rights holder, the date of expiry of any rights.

The method may be one wherein the server supports a payment system, such as Stripe or direct credit card receipts, to allow money to be credited to the accounts of individual users, for example if they have insufficient funds to contribute the amount on a button they pushed.

The method may be one wherein each time a new digital media file is published, its metadata contains one or more financial values, which are assigned to buttons displayed in the web-based media player user interface.

The method may be one wherein each time someone clicks on one of these buttons, money or tokens representing value are deducted from the viewer's account and assigned to the accounts of the people along the distribution chain, including to the account of the original Creator, and to the server provider itself.

The method may be one wherein the server hosts a video editor which allows media to be created and published and the web-based media player user interface to be configured.

The method may be one wherein the server allows a content Creator to upload existing edited content, and to upload their own content for editing.

The method may be one wherein the server includes or provides access to libraries for video, audio, image and other media, either with free content or paid content through supplier mandated charging models.

The method may be one wherein the server allows a content Creator to set a player configuration, which includes the option of one or more payment buttons.

The method may be one wherein every time a payment is made by a viewer, the content Creator receives a share of this payment.

The method may be one wherein the content creator receives a share of any payments received on re-shared or clipped and shared media derived from the content creator's original work.

The method may be one in which the receipts match the proportion of income received from payments for the original video.

The method may be one wherein step (vi) is performed, without using a blockchain. An advantage is energy efficient collection of distribution volumes and distribution pathways for the digital media file.

The method may be one wherein step (vi) is performed, by storing the first link including the data uniquely identifying the digital media file, the first user and the second user. An advantage is accurate and rapid collection of distribution volumes for the digital media file. An advantage is accurate and rapid collection of distribution pathways between users for the digital media file. An advantage is energy efficient collection of distribution volumes and distribution pathways for the digital media file. For example, collection of distribution volumes and distribution pathways for the digital media file is more energy efficient than using a blockchain.

The method may be one wherein in step (iii) the data uniquely identifying the digital media file, the first user and the second user is encrypted, and wherein in step (iv) the encrypted data uniquely identifying the digital media file, the first user and the second user is decrypted. An advantage is that this secures the method against illicit access to the digital media file.

The method may be one wherein step (ii) includes receiving a payment from the first user.

The method may be one including the steps of:
(vii) receiving from the second user a request to share the digital media file identified by the first link with a third user having a respective registered account at the server;
(viii) sending a second link from the server to the third user, for accessing the digital media file, the second link including data uniquely identifying the digital media file, the first user, the second user and the third user;
(ix) the server receiving a selection of the second link by the third user;
(x) the server sending or playing the digital media file to the third user;
(xi) the server recording that the digital media file was shared by the first user with the second user, and by the second user with the third user, to track distribution of the digital media file. An advantage is accurate and rapid collection of distribution volumes for the digital media file. An advantage is accurate and rapid collection of distribution pathways between users for the digital media file. An advantage is energy efficient collection of distribution volumes and distribution pathways for the digital media file.

The method may be one wherein the second link is a Uniform Resource Locator (URL).

The method may be one wherein step (vii) includes using a second user web-based media player including a respective web-based media player user interface, and steps (viii), (ix) and (x) include using a third user web-based media player including a respective web-based media player user interface. An advantage is ease of distribution of the digital media file.

The method may be one wherein step (xi) is performed, without using a blockchain.

The method may be one wherein step (vii) includes receiving a payment from the second user.

The method may be one including the steps of:
(xii) receiving from a user, who has received a previously served link including data uniquely identifying the digital media file, and a chain of users which shared the digital media file, a request to share the digital media file identified by the previously served link with a subsequent user having a respective registered account at the server;
(xiii) sending a further link from the server to the subsequent user, for accessing the digital media file, the further link including data uniquely identifying the digital media file, and a chain of users which shared the digital media file including the first user, the second user, the user and the subsequent user;
(xiv) the server receiving a selection of the further link by the subsequent user;
(xv) the server sending or playing the digital media file to the subsequent user;
(xvi) the server recording that the digital media file was shared by the first user with the second user, and so on along the chain of users up to the subsequent user, to track distribution of the digital media file. An advantage is accurate and rapid collection of distribution volumes for the digital media file. An advantage is accurate and rapid collection of distribution pathways between users for the digital media file. An advantage is energy efficient collection of distribution volumes and distribution pathways for the digital media file.

The method may be one wherein step (xii) includes receiving a payment from the user.

The method may be one including providing the user with digital rights, in response.

The method may be one including tracking the payments back through the chain of media sharing and rights acquisition, including to the original content Creator.

The method may be one including allocating payments depending on share of rights ownership.

The method may be one including sharing income rights for each chain of sharing.

The method may be one wherein the original content Creator receives a proportion of income from all the shared video derived from their original published media.

The method may be one wherein the technology provider takes a share of income from shared media.

The method may be one wherein non-contributors can share content but don't receive a share of income further down the distribution tree of shared content derived from the shared content.

The method may be one which incentivizes viewers financially or otherwise to share Creator content.

The method may be one including charging different amounts depending on the value viewers are willing to pay.

The method may be one including content Creators making revenue on their media without corrupting it with third party advertising.

The method may be one including collecting the contributions from viewers centrally at the server.

The method may be one including allowing time limited distributor rights on shared content.

The method may be one including providing the ability to delete the content and all shares and clips from the server in minimal time.

The method may be one including receiving from a creator who creates the original content, distribution payment parameters and sending to the creator a share of income.

The method may be one including receiving a purchase from a purchaser who purchases rights to the part of the distribution tree starting at a node they create by sharing content, and receiving income from donators or purchasers in the part of the distribution tree which traces back to the node the purchaser shared.

The method may be one wherein the number of levels of sharing the purchaser's rights persist for, and the time these rights persist for, are configuration options settable by the server and/or by the digital media file Creator.

The method may be one wherein the clipped video, when shared, becomes the content which the purchased rights apply to down that branch of the distribution tree from that point in the distribution tree onwards.

The method may be one wherein the server provider receives a portion of income received by the server.

The method may be one including receiving a request to display distribution data of the digital media file, and sending the distribution data of the digital media file for display.

The method may be one wherein the distribution data of the digital media file includes chains of users along which the digital media file was shared.

The method may be one wherein the distribution data of the digital media file includes a distribution tree.

The method may be one wherein the server stores or keeps a record of chains of sharing from original published digital media files.

The method may be one wherein the server is a Blackbird server, or the server is a YouTube server, or an Amazon server, or a Vimeo server, or a HubSpot server, or the server is a cloud server.

The method may be one wherein the digital media file is a digital video file and the digital video file is converted into a compressed format structure, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy. An advantage is that the digital video file can be edited in a rapid and energy efficient way. For example the frames in the highest temporal resolution of frames can be excluded, which reduces the temporal resolution of the frames, but otherwise the digital video file is playable with no further editing.

The method may be one including the further steps of: receiving an electronic edit decision list which defines how to manipulate the compressed format structure;
saving the electronic edit decision list;
receiving a request to provide in a web browser executing on a user terminal a video clip playback corresponding to a video clip defined by the compressed format structure and the electronic edit decision list;
sending to the web browser code executable in the web browser to provide the video clip playback corresponding to the video clip defined by the compressed format structure and the electronic edit decision list, and
responding to requests from the code when executing in the web browser, to provide content corresponding to the compressed format structure, in accordance with the electronic edit decision list, to the web browser, to provide the video clip playback.

An advantage of the method is that video clips may be provided for playback very quickly. An advantage of the method is that video clips may be provided for playback before a corresponding “live” broadcast is available to the public. An advantage of the method is that video clips may be provided for playback without using MPEG format files. An advantage of the method is that video clips may be provided for playback to a user using a web browser executing on a user terminal.

The method may be one including a method for encoding and decoding a video stream comprising dividing the video stream into a first Key frame, and subsequent chunks each comprising 2ⁿ frames, each chunk including a Key frame and 2ⁿ⁻¹ Delta (D^{x}) frames, where x is a positive integer and denotes the level of the Delta frame, and where 2^{x-1} denotes the number of Delta frames at that level in the chunk; the method including the step of constructing D^{x} level frames from adjacent Earlier and Later D^{y} frames, (where y<x and where for y=0, D^{y} is a Key frame), for all frames in a chunk where x>0; wherein the constructing step includes: dividing the frame into Motion Regions representing groups of pixels; determining a pixel group in an Earlier (E: D^{y}) and later (L: D^{y}) frame that is a best match for a pixel group in a Motion Region of a Current (C: D^{x}) frame; determining motion vectors for the best matches for Motion Regions, or by intra-frame compression of frame C, the method including eliminating unnecessary information when building a bitstream such that as x increases, motion vector and other data relating to a combination of D^{x} frames (more numerous than the D^{x-1} frames) is represented by a quantity of data in the bitstream that, for a typical video, increases at a much lower rate than the quantity of frames in D^{x} compared to the quantity of frames in D^{x-1}.

According to a second aspect of the invention, there is provided a server configured to track distribution of a shared digital media file, the server configured to:
(i) make a digital media file available to a plurality of users, each user of the plurality of users having a respective registered account at the server;
(ii) receive from a first user having a respective registered account at the server a request to share the digital media file with a second user having a respective registered account at the server;
(iii) send a first link to the second user, for accessing the digital media file, the first link including data uniquely identifying the digital media file, the first user and the second user;
(iv) receive a selection of the first link by the second user;
(v) send or play the digital media file to the second user;
(vi) record that the digital media file was shared by the first user with the second user, to track distribution of the digital media file. An advantage is accurate and rapid collection of distribution volumes for the digital media file. An advantage is accurate and rapid collection of distribution pathways between users for the digital media file. An advantage is energy efficient collection of distribution volumes and distribution pathways for the digital media file.

The server may be one configured to perform a method of any aspect of the first aspect of the invention.

According to a third aspect of the invention, there is provided a system including a first user terminal, a second user terminal, and a server configured to track distribution of a shared digital media file, wherein:
(i) the server is configured to make a digital media file available to a plurality of user terminals, each user of the plurality of user terminals having a respective registered account at the server;
(ii) the server is configured to receive from a first user using the first user terminal, and having a respective registered account at the server, a request to share the digital media file with a second user using the second user terminal, and having a respective registered account at the server;
(iii) the server is configured to send a first link to the second user terminal, for accessing the digital media file, the first link including data uniquely identifying the digital media file, the first user and the second user;
(iv) the server is configured to receive a selection of the first link by the second user using the second user terminal;
(v) the server is configured to send or to play the digital media file to the second user terminal;
(vi) the server is configured to record that the digital media file was shared by the first user with the second user, to track distribution of the digital media file. An advantage is accurate and rapid collection of distribution volumes for the digital media file. An advantage is accurate and rapid collection of distribution pathways between users for the digital media file. An advantage is energy efficient collection of distribution volumes and distribution pathways for the digital media file.

The system may be one configured to perform a method of any aspect of the first aspect of the invention.

According to a fourth aspect of the invention, there is provided a computer program product executable on a server to track distribution of a shared digital media file, the computer program product executable on the server to:
(i) make a digital media file available to a plurality of users, each user of the plurality of users having a respective registered account at the server;
(ii) receive from a first user having a respective registered account at the server a request to share the digital media file with a second user having a respective registered account at the server;
(iii) send a first link to the second user, for accessing the digital media file, the first link including data uniquely identifying the digital media file, the first user and the second user;
(iv) receive a selection of the first link by the second user;
(v) send or play the digital media file to the second user;
(vi) record that the digital media file was shared by the first user with the second user, to track distribution of the digital media file. An advantage is accurate and rapid collection of distribution pathways between users for the digital media file. An advantage is energy efficient collection of distribution volumes and distribution pathways for the digital media file.

The computer program product may be executable on the server to perform a method of any aspect of the first aspect of the invention.

According to a fifth aspect of the invention, there is provided a method for content creators to monetize video and/or other media content through a player by enabling third parties who view the media to easily contribute income to the content creator.

The method may be one which incentivizes viewers of the media to share the content by enabling the viewers to become quasi-distributors, creating an income for themselves by sharing the content.

The method may be one which leads to rapid positive feedback of distribution volumes for the best videos, enriching both the original content creators and the quasi-distributors who helped to spread the video.

According to a sixth aspect of the invention, there is provided a method, executable on a computer processor, for tracking the payments back through the chain of media sharing and rights acquisition, including to the original content Creator.

According to a seventh aspect of the invention, there is provided a method, executable on a computer processor, where the original content Creator receives a proportion of income from all the shared video derived from their original published media.

According to an eighth aspect of the invention, there is provided a method, executable on a computer processor, where the technology provider takes a share of income from shared media.

According to a ninth aspect of the invention, there is provided a method, executable on a computer processor, including an energy efficient way for ownership and distribution chains to be recorded on the server without need for energy inefficient block chains.

According to a tenth aspect of the invention, there is provided a method, executable on a computer processor, to allow time limited distributor rights on shared content.

According to an eleventh aspect of the invention, there is provided a back end including a computer processor which keeps track of distribution chains.

According to a twelfth aspect of the invention, there is provided a server, the server hosting media content, the server configured to determine the Uniform Resource

Locator (URL) of any media served, the server serving the content through a media Player configured to receive media served from the server, wherein the media is shareable using the media Player interface, and all sharing through this interface is recorded on the server.

The server may be one wherein the server stores or keeps a record of chains of sharing from the original published content.

The method, back end or server of any of the fifth to twelfth aspects of the invention may include a method of any aspect of the first aspect of the invention, or may be configured to perform a method of any aspect of the first aspect of the invention.

Aspects of the invention may be combined.

In this document, where a digital media file is referred to, the digital media file may be a single digital media file, or the digital media file may comprise a set of digital media files. For example, a digital media file may comprise a plurality of digital media files. For example, a digital media file comprising a plurality of digital media files may be such that the plurality of digital media files are Blackbird Media files.

### BRIEF DESCRIPTION OF THE FIGURES

Aspects of the invention will now be described, by way of example(s), with reference to the following Figures, in which:

FIG. 1 shows an example Player interface displayed on a screen of a computing device.

FIG. 2 shows an example development of shared/purchased content, in a distribution tree.

FIG. 3 is an example of a method for providing video clips very quickly.

FIG. 4 is an example of a system for providing video clips very quickly.

### DETAILED DESCRIPTION

In an example, there is provided a method for content creators to monetize video and/or other media content through a player by enabling third parties who view the media to easily contribute income to the content creator. The method may also incentivize viewers of the media to share the content by enabling the viewers to become quasi-distributors, creating an income for themselves by sharing the content. An advantage is that this will lead to rapid positive feedback of distribution volumes for the best videos, enriching both the original content creators and the quasi-distributors who helped to spread the video.

Examples of the invention may include a system which may include one or more of the following:
An editor for creating media, executable on a computer processor.
A way to publish media, possibly as part of the editor executable on the computer processor, including
   setting one or more prices for users to pay for various services.
A platform, e.g. executable on a computer processor, for hosting media.
A Player, executable on a computer processor, for
   playing back the media.
   enabling sharing of the media, preferably without requiring re-rendering.
   clipping content prior to sharing clipped content, preferably without requiring re-rendering.
   a method for paying for digital rights with one click.
When rights have been purchased
   a method, e.g. executable on a computer processor, for tracking the payments back through the chain of media sharing and rights acquisition, including to the original content Creator.
   a method, e.g. executable on a computer processor, for allocating payments depending on share of rights ownership.
   a method, e.g. executable on a computer processor, of sharing income rights for each chain of sharing/distribution.
A method, e.g. executable on a computer processor, where the original content Creator receives a proportion of income from all the shared video derived from their original published media.
A method, e.g. executable on a computer processor, where the technology provider takes a share of income from shared media.
A method, e.g. executable on a computer processor, where non-contributors can share content but don't receive a share of income further down the distribution tree of shared content derived from the shared content.
A method, executable on a computer processor, where videos can be clipped or re-clipped before being shared.
A method, e.g. executable on a computer processor, to incentivize viewers financially or otherwise to share Creator content.
A method, e.g. executable on a computer processor, for charging multiple amounts depending on the value viewers are willing to pay.
A method, e.g. executable on a computer processor, for content Creators to make revenue on their media without corrupting it with third party advertising.
A way, e.g. executable on a computer processor, of collecting the contributions from viewers centrally.
An energy efficient way for ownership and distribution chains to be recorded on the server without need for energy inefficient block chains, e.g. executable on a computer processor.
A way to allow time limited distributor rights on shared content, e.g. executable on a computer processor.
The ability to delete the content and all shares and clips copied from the Platform in minimal time, e.g. executable on a computer processor.

Examples of the invention may comprise technical components, as follows. Examples of the invention may be used by multiple human participants, as follows. One or more of the following may be provided:
1. A Player which allows media to be played, clipped, shared and payments authorized, executable on a computer processor.
2. A back end which keeps track of distribution chains, including a computer processor.
3. A way to protect from people who fake the chain of sharers, through using coded URLs, e.g. executable on a computer processor.
4. A Creator who creates the original content, sets the distribution payment parameters and receives a share of income.
5. Zero, one or more viewers who watch the content without payment.
6. Zero, one or more Sharers who view and share the content without payment.
7. Zero, one or more Clippers who clip or sub-clip the content and share it without payment.
8. Zero, one or more Donators who donate money to the content distribution chain.
9. Zero, one or more Purchasers who purchase rights to the part of the distribution tree starting at the nodes they create by sharing the content, receiving income from Donators and Purchasers in the part of the distribution tree which traces back to the nodes they shared, e.g. within certain constraints.
10. The technology provider who receives a cut of the income.
11. The platform provider who receives a cut of the income and hosts the content.

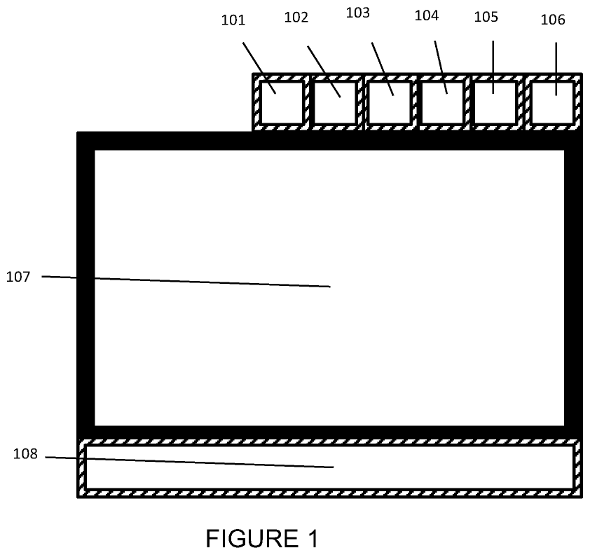

FIG. 1 shows an example of a Player displayed on a screen of a computing device.

In an example, the invention includes a Player, executable on a computing device, for example as shown in FIG. 1.

The exact definition and positions of the buttons shown in FIG. 1 is for illustration only. In an example, the Player includes payment buttons.

Buttons 101, 102, 103, shown for example in FIG. 1, represent value. In an example, the values displayed on the buttons is chosen by the Creator when they publish the media. They may (by way of example only) be three in number and contain the text “$1”, “$5”, “$20”.

Buttons 104, 105, 106, shown for example in FIG. 1, (or some other number of buttons for standard player features) may contain player features such as play full screen/in a window; change video playback size; change video playback resolution; share media or a market clip of the media.

Area 107, shown for example in FIG. 1, is the main media frame, typically a video frame or image. In some implementations, this can be active, allowing navigation and playback controls or the functions of any of the buttons mentioned herein, which may appear and disappear over the area as required.

Area 108, shown for example in FIG. 1, is the edit navigation area. This may include buttons for playback at various speeds backwards and forwards, marking start and end points of clips (which may alternatively be achieved via interaction with the video area), single step (or larger jumps) backwards and forwards, jog and shuttle on a navigation bar.

### Platform-Centric Model

In an example, the platform hosts the media content. In an example, the platform determines the Uniform Resource Locator (URL) of any media served. In an example, the platform serves the content through its own media Player. In an example, the media is shared using the Player interface, and all sharing through this interface is recorded on the Platform.

In an example, the Platform stores or keeps a record of chains of sharing from the original published content. In a preferred web version of the technology, this is encoded in the URL of the video.

In an example, a URL of a video viewed by registered user A on the platform is
www.blackbird.com/video12345678/userA

where video12345678 is the unique identity of the video viewed by user A, where user A is registered at the platform. In an example, this URL may be randomized, or at least partly encrypted, to a URL which is provided by the platform, and which is recognized by the platform as corresponding to www.blackbird.com/video12345678/userA, such as
www.blackbird.com/fhm5fguylf6tjysrj7djzha

In an example, when the video is shared by user A with user B, where user B is registered at the platform, the platform determines the URL of the shared video to be:
www.blackbird.com/video12345678/userA/userB

where video12345678 is the unique identity of the video shared by user A with user B, where users A and B are registered at the platform. In an example, this URL may be randomized, or at least partly encrypted, to a URL which is provided by the platform, and which is recognized by the platform as corresponding to www.blackbird.com/video12345678/userA/userB, such as
www.blackbird.com/kd2gopasdnps0dnjs5bg

The Platform stores or keeps a record of the chain of sharing from the original published content (e.g. video12345678), e.g. shared by user A with user B. In an example, this may be done by storing the non-randomized served URLs. In an example, this may be done by storing the randomized served URLs, together with a key to recover each original URL from its randomized URL.

In an example, when the video is shared by user A with user B who is registered at the platform, and when the video is shared by user B with user C who is registered at the platform, the platform determines the URL of the shared video to be:
www.blackbird.com/video12345678/userA/userB/userC

where video12345678 is the unique identity of the video shared by user A with user B, and shared by user B with user C, where users A, B and C are registered at the platform. In an example, this URL may be randomized, or at least partly encrypted, to a URL which is provided by the platform, and which is recognized by the platform as corresponding to www.blackbird.com/video12345678/userA/userB/userC, such as
www.blackbird.com/dzg3njstdfgj4fgnfxg3kkhfxkc9gkgc

The Platform stores or keeps a record of the chain of sharing from the original published content (e.g. video12345678), e.g. shared by user A with user B, and shared by user B with user C. In an example, this may be done by storing the non-randomized served URLs. In an example, this may be done by storing the randomized served URLs, together with a key to recover each original URL from its randomized URL.

In one implementation, each paying user has a user id on the Platform. In an example, the rights and payment metadata associated with each clip are represented by a unique random string attached to the URL. In an example, this string is used as a key in a key:value dictionary, where the value contains all the information required to track rights, for example, the ids of the Creator and all subsequent rights holders, the share of income rights purchased by each rights holder, the date of expiry of any rights. The random strings are sufficient in length to be sparse, so anyone guessing a valid URL has minimal chance of success.

In an example, Social Media platforms, or others not using a web URL to access the file, for example using this natively or through an app, can record the key for the chain of rights for this video in other ways, such as the media ID.

In an example, each time a new piece of media is published, its metadata will contain one or more financial values, which are assigned to buttons. Each time someone clicks on one of these buttons, money or tokens representing value are deducted from the viewer's account and assigned to the accounts of the people along the distribution chain, including to the account of the original Creator, and to the platform itself.

In an example, this value is distributed from time-to-time to the relevant users, for example though access to the tools or possibly as a cash payment.

In an example, the platform supports a payment system, such as Stripe or direct credit card receipts, to allow money to be credited to the platform accounts of individual users, for example if they have insufficient funds to contribute the amount on the button they pushed.

In a preferred implementation, the platform hosts a video editor which allows media to be created and published, and the Player to be configured efficiently.

In a preferred implementation, this editor supports Faster Than Live (registered trade mark in the USA) publishing and hosting, for example as described in WO2018197911A1 or in U.S. Pat. No. 11,057,657B2 which are incorporated by reference, which allows sharing clips and sub-clips to be created efficiently without rendering or re-rendering.

In a preferred implementation, the video content is compressed using Blackbird format codecs, which supports numerous Player features, including frame accurate access, for example as described in WO2018127695A2 or in U.S. Pat. No. 11,082,699B2 which are incorporated by reference.

### Creator-Centric Model

In a typical use case, the content Creator opens an account in the Platform. This allows the content Creator to upload existing edited content, and to upload their own content for editing. This platform may also include or provide access to libraries for video, audio, image and other media, either with free content or paid content through supplier mandated charging models.

In a typical use case, the content Creator takes one of their finished works and publishes it. The content Creator has the option to set a player configuration, which includes the option of one or more payment buttons.

In a typical use case, every time a payment is made by a viewer, the content Creator receives a share of this payment. In a preferred implementation, this is credited to the content Creator's Platform account.

In a typical use case, the content creator also receives a share of any payments received on re-shared or clipped and shared media derived from the content creator's original work. In one implementation, the receipts will match the proportion of income received from payments for the original video.

### Viewer-Centric Model

The Viewer may find the media as they would other media, for example hosted directly on a website or through social media. The Player, typically running in JavaScript in a web browser, is therefore typically cross platform, so will work on many devices, though Apps and other implementations are possible.

The Viewer may watch the content for free. The Player can provide a range of features, including by way of example only, frame accurate access, a choice of playback speeds backwards and forwards, jog and shuttle, a choice of frame size and resolution, including full screen, as well as clipping options, sharing options and payment options.

The Viewer does not benefit directly from the success of the content, regardless of whether this is assisted by the decision of a Viewer to share either the entire media or a clip from it.

### Donator-Centric View

A Donator is any Viewer who contributes to the chain of creation and distribution. In a typical implementation, the donator will do this by clicking on one of the payment buttons eg a $1 button—the value of these may have been set by the content Creator.

If the Donator does not have a Platform account, they are given the option to open a Platform account and add some money to the Platform account, for example by credit card, and continue as below. The donator may also have the option to make a one-off credit card donation, in which case no information about such donators need be held in the platform long term.

If the Donator has an account but the account contains insufficient funds to make the donation represented by the button, the Donator is given options to add money to their account or to use a button with a smaller value attached (if present), and continue as below.

If the Donator already has a Platform account with sufficient funds, this money (tokens could be used instead for convenience or for example in jurisdictions in which holding customer money is restricted by law) is deducted from the donator account and dispersed up the tree of distribution in the proportions specified by the Platform, including a payment to the Creator for this media. The Creator may also have some

Player/Platform configuration options when they publish such as the number of levels of distribution before each distributor ceases to benefit from further distribution.

The Donator does not benefit directly from any success the video has as a result of their donation, which is designed to allow the donator to provide voluntary support for the Creator and distribution chain which led the donator to the video.

### Purchaser-Centric View

If a Donator likes, they may share the content through sharing buttons in the Player.

If the donator decides to share all or part of the content, their donation becomes a purchase, they become a Purchaser, and they subsequently receive a share of the income contributed by Donators and Purchasers further down the branch of the distribution tree they have started by sharing this video.

The number of levels of sharing the donator's rights persist for, and the time these rights persist for, may be configuration options set by the Platform and/or the Creator, and may depend on the number of tokens purchased. An example of one level of sharing is user A, who views originally published content, shares the content with user B. An example of two levels of sharing is user A, who views originally published content, shares the content with user B, and user B then shares the content with user C. An example of three levels of sharing is user A, who views originally published content, shares the content with user B, and user B then shares the content with user C, and user C then shares the content with user D.

In one implementation, the last <n> tokens purchased (where n takes a value such as 10 or 100) entitle the purchaser to a corresponding proportion of the money/tokens distributed to the purchasers. In another implementation, the purchasers of the most recent <n> tokens purchased share the distribution fund. In another configuration, only the last <m> (where m may take a value from one to an arbitrarily large number) purchasers are entitled to a share of the downstream revenue. In another configuration, all contributors for the preceding 12 months share the revenue from the content contributions.

Just as tokens are spent from the Purchaser's account, the Creator and Donator and Purchaser income is credited to the Creators and Purchasers' accounts. This could be spent on purchasing shares of video distribution income in the system, on Editor or

Player access or otherwise, or returned in some form to the account holder by the Platform.

### Payment details

There are many payment systems, but the spontaneity of the purchases is considered maximized when people can pay directly from an existing account (or open a new account directly when needed) by clicking on the payment buttons in the Platform.

### Distribution Tree

The Distribution tree shows which video shares came from which other video shares, all the way back to the original Creator publish.

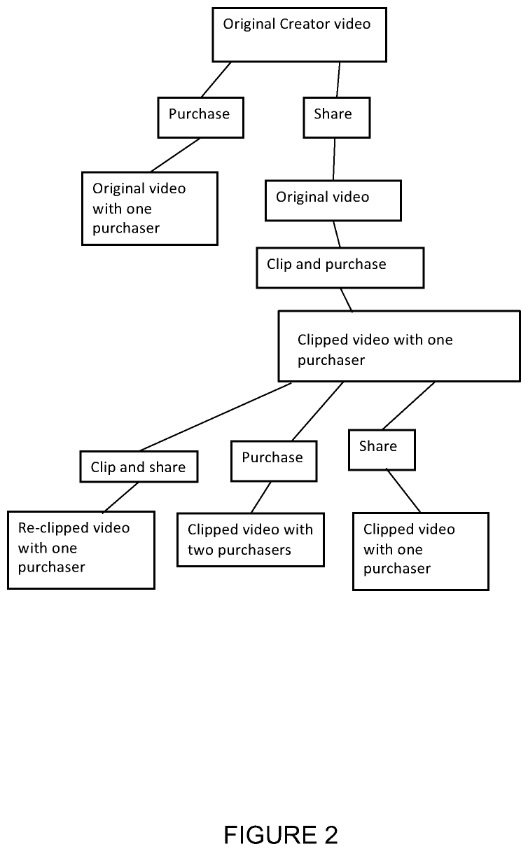

Each sharer starts a new branch of the Distribution tree. An example of such a Distribution tree is illustrated in FIG. 2, with the lines showing the action which created this shared video and the boxes showing the status of each video after the sharing. For each video, if there are no further shares on their branch, their leaf node does not spread further, though donations through that share (and any other shared videos) will ripple back up through the Distribution tree to the entitled previous Purchasers, the content Creator and the Platform owner.

### Clipping Details

In an example, people watching the video have the option to edit, to clip the video, before sharing the clipped video portion, which includes clipped video frames. Clips are typically consecutive frames from the original video, though the option to combine sections of frames consecutively may be available.

In an example, when shared, the clipped content is visible through the Player with the same settings as the original content, e.g. with the same price options and share options set by the original Creator.

In an example, the clipped video, when shared, becomes the content which the purchased rights apply to down that branch of the distribution tree from that point in the distribution tree onwards.

### Sharing Details

In examples, when media (e.g. a video) is shared, this can be through a Platform controlled website, a Viewer or Purchaser controlled website or through social media websites which support web links or a native Player application or app.

### NFTs

As an alternative to the Platform tracking ownership, any combination of the above ownership features can be implemented using a non-fungible token (NFT) or non-fungible tokens (NFTs) to track the chain of ownership rights. A non-fungible token is a unique digital identifier that cannot be copied, substituted, or subdivided, that is recorded in a blockchain, and that is used to certify authenticity and ownership.

### Blackbird

In one implementation the Platform is the Blackbird Video Platform, and the Player/Clipper is the Blackbird Player/Clipper.

### Tokens

Tokens may be stored in accounts instead of currency denominated value to simplify regulatory issues with storing client money.

### Use Cases

Some example use cases are:
not having all the user types in all cases eg not having free sharing users in some scenarios.
extra/bonus features available to reward some users e.g. for enough tokens spent or content earned.
a dashboard for each level of user to show how views and income is arriving.
editor integrations including:

direct integration with the editor
e.g. making per frame viewing and income available to the person editing/re-editing the content.
drag and drop media elements from media in the Player into a Blackbird editor account for re-use.
a marketplace for charging for content.
e.g. graphics, video clips, audio, memes-either one off, share of income or charge per view. Tokens/fractions of tokens representing value would be spent and earned within the system.

### Registering an Account at a Server

In an example, a user registers an account at a server by providing their name and an email address, through a web interface. In an example, a user registers an account at a server by providing their name, their mobile telephone number and an email address, through a web interface. In an example, a user registers an account at a server by providing their name, their mobile telephone number and an email address, and a payment channel, such as a credit card number or bank account details, through a web interface. In an example, a user registers an account at a server by providing their name, their mobile telephone number and an email address, and a payment channel, such as a credit card number or bank account details, and a payment through the payment channel, through a web interface. In an example, a user registers an account at a server by providing their name, their mobile telephone number and an email address, a username and a password, and a payment channel, such as a credit card number or bank account details, and a payment through the payment channel, through a web interface.

### Note

Combinations of the above features may be included in different implementations of this invention.

### TECHNICAL DISCLOSURES

This section of this document relates to technical disclosures made in WO2018197911A1, which may relate to the inventions of the present document.

According to a first aspect of these technical disclosures, there is provided a computer-implemented method of providing video clip playback, the method including the steps of:
(i) receiving a video feed;
(ii) converting the video feed into a compressed format structure, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy;
(iii) uploading the compressed format structure to a first server;
(iv) receiving an electronic edit decision list which defines how to manipulate the compressed format structure;
(v) saving the electronic edit decision list to the first server, or to a second server;
(vi) receiving a request to provide in a web browser executing on a user terminal a video clip playback corresponding to a video clip defined by the compressed format structure and the electronic edit decision list;
(vii) sending to the web browser code executable in the web browser to provide the video clip playback corresponding to the video clip defined by the compressed format structure stored on the first server and the electronic edit decision list saved on the first server or on the second server, and
(viii) responding to requests from the code when executing in the web browser, to provide content corresponding to the compressed format structure stored on the first server, in accordance with the electronic edit decision list saved on the first server or on the second server, to the web browser, to provide the video clip playback.

An advantage of the method is that video clips may be provided for playback very quickly. An advantage of the method is that video clips may be provided for playback before a corresponding “live” broadcast is available to the public. An advantage of the method is that video clips may be provided for playback without using MPEG format files. An advantage of the method is that video clips may be provided for playback to a user using a web browser executing on a user terminal.

In an example of a compressed format structure, the lowest level of temporal resolution of frames of the hierarchy provides a frame at every second, such as at 0 s, 1 s, 2 s, 3 s. The next lowest level of temporal resolution of frames of the hierarchy provides a frame at every half second, such as at 0.5 s, 1.5 s, 2.5 s, 3.5 s. But to play the frames at the resolution of the next lowest level of temporal resolution of frames of the hierarchy, it is necessary to use frames from the two lowest levels of the hierarchy, to provide frames at 0 s, 0.5 s, 1 s, 1.5 s, 2 s, 2.5 s, 3 s, 3.5 s. The next next lowest level of temporal resolution of frames of the hierarchy provides a frame at every quarter second, such as at 0.25 s, 0.75 s, 1.25 s, 1.75 s, 2.25 s, 2.75 s, 3.25 s, 3.75 s. But to play the frames at the resolution of the next next lowest level of temporal resolution of frames of the hierarchy, it is necessary to use frames from the three lowest levels of the hierarchy, to provide frames at 0 s, 0.25 s, 0.5 s, 0.75 s, 1 s, 1.25 s, 1.5 s, 1.75 s, 2 s, 2.25 s, 2.5 s, 2.75 s, 3 s, 3.25 s, 3.5 s, 3.75 s.

The method may be one in which the video feed is a live video feed. An advantage of the method is that video clips may be provided for playback before a corresponding “live” broadcast is available to the public.

The method may be one in which the live video feed is a live sports video feed.

The method may be one in which the video clip playback is real time video clip playback. An advantage of the method is that video clips may be provided for playback very quickly.

The method may be one in which converting the video feed into the compressed format structure is performed in real time. An advantage of the method is that video clips may be provided for playback very quickly.

The method may be one in which the code executable in the web browser is JavaScript code. An advantage is that video clip playback may be provided very simply in a web browser user interface familiar to a typical user, without requiring the user to install playback software or hardware.

The method may be one including the step of executing the code in the web browser to provide the video clip playback corresponding to the video clip defined by the compressed format structure stored on the first server and the electronic edit decision list saved on the first server or on the second server. An advantage of the method is that video clips may be provided for playback very quickly.

The method may be one including the step of the web browser code executing in the web browser to provide backwards play and forwards play at multiple speeds and at high displayed frame rate. An advantage of the method is that versatile playback functions are provided.

The method may be one including the step of the web browser code executing in the web browser to create no significant garbage while the web browser code is running. An advantage is very well controlled memory management while the code is running in the web browser. A further advantage is that the programming language garbage collector does not block program execution for long enough to cause skipped frames on playback.

The method may be one in which the web browser code is executable in the web browser without configuration or installation. An advantage is ease of use by a user.

The method may be one including the step of providing the compressed format structure in chunks to a video editor, wherein the video editor is operable to generate the electronic edit decision list. An advantage is that the video clip may be generated and accessed more quickly.

The method may be one in which the video editor is operable to provide editing accurate to a single frame. An advantage is that a video clip with the desired start frame and with the desired end frame may be generated. This is desirable, in order to generate very high quality video clips.

The method may be one in which the video editor is arranged to request and to receive frames at the highest level of temporal resolution in the hierarchy, in the vicinity of a selected frame.

The method may be one in which the video editor includes video/audio précis display hardware and/or software, which provides a visual summary of the video and/or audio, such as a navigation bar, which summarises the content at multiple temporal scales and allows fast and convenient jog and/or shuttle navigation through an action such as mouse clicking or dragging on a display, as well as further uses such as rapid scene detection and detection of significant parts of the content by an artificial intelligence (AI) algorithm.

The method may be one in which the first server is a cloud server. An advantage is more efficient distribution of a video clip to users situated on the world wide web.

The method may be one in which the second server is a cloud server. An advantage is more efficient distribution of a video clip to users situated on the world wide web.

The method may be one including the step of the electronic edit decision list being generated even though the compressed format structure has not finished being stored on the first server. An advantage of the method is that video clips may be provided for playback very quickly. An advantage of the method is that video clips may be provided for playback before a corresponding “live” broadcast is available to the public.

The method may be one including the step of the compressed format structure being stored on an ingest server, before the compressed format structure is uploaded to the first server. An advantage of the method is that video clips may be provided for playback very quickly. An advantage of the method is that video clips may be provided for playback before a corresponding “live” broadcast is available to the public.

The method may be one in which the code is executable to download relevant video, audio, still, text and other files, including metadata files, from the first server or from the ingest server.

The method may be one in which the code is executable to read and to interpret the electronic EDL.

The method may be one in which the code is executable to combine files in the compressed format structure to play back the edited video at any of the spatial resolutions in the compressed format structure. An advantage is the flexibility to deliver the most suitable spatial resolution given limitations on data delivery speed to the user terminal.

The method may be one including an Edit step, in which a video editor system enables editing of video, audio, slides, titles and other media and metadata through the first server, to provide one or more electronic Edit Decision Lists.

The method may be one including a Player view step, in which opening a browser or other software gives access to the edited videos by real time playback of the electronic EDLs saved in step (v).

The method may be one in which a Player, which runs entirely in JavaScript and has a relatively small footprint, is included in the web page code.

The method may be one including being able to provide video clips in less than 60 seconds from an original recording made using a video camera.

The method may be one including being able to provide video clips in less than 30 seconds from an original recording made using a video camera.

The method may be one including providing the video clip playback on a mobile computing device, on a mobile phone, on a smartphone, on a tablet computer, on a smart watch, on a laptop computer, on a desktop computers, or on a smart TV.

The method may be one in which the code is executable to provide live controls over some combination of video resolution, image size, playback speed, position through jog and/or shuttle, keyboard short cuts and other controls.

The method may be one in which the compressed format structure includes loss free compression.

The method may be one in which the loss free compression includes use of Transition Tables; an example of the use of Transition Tables is described in the “IMPROVEMENTS TO REPRESENTATIONS OF COMPRESSED VIDEO” disclosures made in WO2005048607A1, U.S. Pat. Nos. 9,179,143B2 and 8,711,944B2, which are incorporated by reference.

The method may be one in which the code uses a video codec, wherein the video codec supports private keys to randomise the initial state of its Transition Tables, making each bitstream randomised.

The method may be one in which a new player, incompatible with a previous player, is generated by providing new private keys.

The method may be one in which an order in which video and audio of the compressed format structure is uploaded to the first server is determined by an upload ordering system.

The method may be one including the steps of the upload ordering system
(a) uploading non-uploaded compressed audio, where available, as the highest priority;
(b) uploading non-uploaded coarsest temporal resolution video frames as the next highest priority;
(c) uploading the non-uploaded next-coarsest temporal resolution video frames as the next highest priority;
(d) uploading in this way until all video and audio frames have been uploaded.

The method may be one in which the method includes use of an Electronic EDL interpreter library hardware and/or software to enable electronic EDLs, and the sources they link to, to be converted into decompressed frames and audio samples, in real time for playback.

The method may be one in which the method includes use of a Web-based video editor operable to create a cloud-hosted web page which can be accessed over a wide area network such as the internet and which contains a video player which plays back the published video.

The method may be one in which no time is required to upload an edited video to a renderer, or to a distribution network, because the video clip playback corresponds to a video clip defined by the compressed format structure and the electronic edit decision list, and because the video clip playback is provided using the web browser code.

In a different example, the method of the first aspect of these technical disclosures is modified to provide a method which includes only steps (i) to (v) of the method of the first aspect of these technical disclosures. In a different example, the method of the first aspect of these technical disclosures is modified to provide a method which includes only steps (i) to (vi) of the method of the first aspect of these technical disclosures. In a different example, the method of the first aspect of these technical disclosures is modified to provide a method which includes only steps (i) to (vii) of the method of the first aspect of these technical disclosures.

According to a second aspect of these technical disclosures, there is provided a processing system including a processor and a first server, the system configured to provide video clip playback, wherein
(i) the processor is configured to receive a video feed;
(ii) the processor is configured to convert the video feed into a compressed format structure, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy;
(iii) the processor is configured to upload the compressed format structure to a first server;
(iv) the processor is configured to receive an electronic edit decision list which defines how to manipulate the compressed format structure;
(v) the processor is configured to save the electronic edit decision list to the first server, or to a second server wherein the system includes the second server;
(vi) the processor is configured to receive a request to provide in a web browser executing on a user terminal a video clip playback corresponding to a video clip defined by the compressed format structure and the electronic edit decision list;
(vii) the processor is configured to send to the web browser code executable in the web browser to provide the video clip playback corresponding to the video clip defined by the compressed format structure stored on the first server and the electronic edit decision list saved on the first server or on the second server, and
(viii) the processor is configured to respond to requests from the code when executing in the web browser, to provide content corresponding to the compressed format structure stored on the first server, in accordance with the electronic edit decision list saved on the first server or on the second server, to the web browser, to provide the video clip playback.

The system may be configured to perform a method of any aspect according to a first aspect of these technical disclosures.

In a different example, the system of the second aspect of these technical disclosures is modified to provide a system which includes only limitations (i) to (v) of the system of the second aspect of these technical disclosures. In a different example, the system of the second aspect of these technical disclosures is modified to provide a system which includes only limitations (i) to (vi) of the system of the second aspect of these technical disclosures. In a different example, the system of the second aspect of these technical disclosures is modified to provide a system which includes only limitations (i) to (vii) of the system of the second aspect of these technical disclosures.

According to a third aspect of these technical disclosures, there is provided a processor, wherein
(i) the processor is configured to receive a video feed;
(ii) the processor is configured to convert the video feed into a compressed format structure, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy;
(iii) the processor is configured to upload the compressed format structure to a first server;
(iv) the processor is configured to receive an electronic edit decision list which defines how to manipulate the compressed format structure;
(v) the processor is configured to save the electronic edit decision list to the first server or to a second server;
(vi) the processor is configured to receive a request to provide in a web browser executing on a user terminal a video clip playback corresponding to a video clip defined by the compressed format structure and the electronic edit decision list;
(vii) the processor is configured to send to the web browser code executable in the web browser to provide the video clip playback corresponding to the video clip defined by the compressed format structure stored on the first server and the electronic edit decision list saved on the first server or on the second server, and
(viii) the processor is configured to respond to requests from the code when executing in the web browser, to provide content corresponding to the compressed format structure stored on the first server, in accordance with the electronic edit decision list saved on the first server or on the second server, to the web browser, to provide the video clip playback.

The processor may be configured to perform a method of any aspect according to a first aspect of these technical disclosures.

In a different example, the processor of the third aspect of these technical disclosures is modified to provide a processor which includes only limitations (i) to (v) of the processor of the third aspect of these technical disclosures. In a different example, the processor of the third aspect of these technical disclosures is modified to provide a processor which includes only limitations (i) to (vi) of the processor of the third aspect of these technical disclosures. In a different example, the processor of the third aspect of these technical disclosures is modified to provide a processor which includes only limitations (i) to (vii) of the processor of the third aspect of these technical disclosures.

According to a fourth aspect of these technical disclosures, there is provided computer code, downloadable to a web browser executing on a user terminal and executable in the web browser to provide a video clip playback corresponding to a video clip defined by a compressed format structure stored on a first server and an electronic edit decision list saved on the first server or on a second server, wherein the compressed format structure includes a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy, the computer code executable in the web browser to:
(i) request content corresponding to the compressed format structure stored on the first server, in accordance with the electronic edit decision list saved on the first server or on the second server, and
(ii) provide the video clip playback.

An advantage is that video clip playback may be provided very simply in a web browser user interface familiar to a typical user, without requiring the user to install playback software or hardware.

The computer code may be arranged not to generate significant quantities of garbage. An advantage is improved memory management. A further advantage is that the programming language garbage collector does not block program execution for long enough to cause skipped frames on playback.

The computer code may be Java code or JavaScript code.

The computer code may be executable in the browser without configuration or installation.

The computer code may be executable in the browser to provide one or more of the following options:
a choice of video size;
a full-screen option;
jog at full video playback resolution;
shuttle at full video playback resolution;
playback at multiple speeds forwards and backwards;
a help screen;
support for keyboard short cuts;
an informative navigation bar (177);
playback of a quickly provided published video clip, as soon as it is published;
gradual degradation of experience where bandwidth is limited;
minimal delays for buffering;
internal caches for compressed and decompressed data;
ability to skip frames on playback where required;
ability to clip sections of Ingest (1710) videos or FTL Web Player (1715) videos and republish new web pages containing these subsets.

The computer code may be executable in the browser to provide the video clip playback in real time without any pre-rendering.

The computer code may be executable in the browser to request content directly from an ingest (Edge) server, or from the cloud, which prioritises such uploads.

The computer code may be executable in the browser to request the relevant frames before they are reached and to play back as many frames as are available.

The computer code may be executable in the browser to maximise frame rate, without buffering, by downloading, decompressing and displaying appropriate groups of video frames as it plays back.

The computer code may be executable in the browser to use the most local copy of the files it requires, minimising server load, and maximising download speed.

The computer code may be executable in the browser such that memory used is allocated in one block at the start.

The computer code may be executable in the browser to use its own memory management system.

The computer code may be included in web page code.

In a different example, there is provided computer code, executable on a user terminal and not executable in a web browser, the computer code executable to provide a video clip playback corresponding to a video clip defined by a compressed format structure stored on a first server and an electronic edit decision list saved on the first server or on a second server, wherein the compressed format structure includes a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy, the computer code executable on the user terminal to:
(i) request content corresponding to the compressed format structure stored on the first server, in accordance with the electronic edit decision list saved on the first server or on the second server, and
(ii) to provide the video clip playback.

Such a computer code different example could be provided in an application for a smartphone, for a tablet computer, for a desktop computer, for a smart watch or for a smart TV.

According to a fifth aspect of these technical disclosures, there is provided a system including the processing system of any aspect according to the second aspect of these technical disclosures, a user terminal, and the computer code according to any aspect of the fourth aspect of these technical disclosures, the computer code executing in the web browser on the user terminal.

### DETAILS RELATING TO THE TECHNICAL DISCLOSURES

This section of this document relates to technical disclosures made in WO2018197911A1, which may relate to the inventions of the present document.

First of all, it is worth understanding what the term “live” on a television or radio broadcast actually signifies. To meet regulatory requirements, such as beeping out swear words or masking out offensive video content, the transmission is often delayed by up to 30 seconds. This gives time for the offending content to be deleted or replaced. You can hear this for yourself by taking part in a live radio phone in. Keeping the “live” illusion is the main reason they are always at pains to tell you to switch off any radios you have on—hearing a repeat of a previously broadcast section would give the game away. So, often “live” broadcast is not actually live, but delayed by 30 seconds or so.

Internet editing solutions often take in a “live” internet protocol (IP) video feed, such as in HTTP Live Streaming (HLS) format. With a ten second file chunk size, these formats can be forty seconds behind real time by the time they are published. For example, a typical data flow may introduce the following delays: 1 second compression latency on the feed coming in; 10 seconds wait to compress to the end of a 10 second chunk; 4 seconds to upload the default resolution to a server; 10 seconds to decompress and recompress in various data rates for distribution; 5 seconds for the player to realise the chunk is available; 10 seconds to download file to decompress; 5 seconds to decompress and display file (allowing some slack for lost packets so these don't break the smooth video playback).

The upshot is that whether the feed comes from a live TV broadcast (the smartphone pirated case) or a live HLS stream (the professional IP case), an approximately 30 second latency on the availability of the source limits the delay of the edited highlights to at least 30 seconds.

An advantage of these technical disclosures is that it may allow the edited content to appear before either the TV broadcast or the HLS internet feed arrives “live”—hence Faster than Live (FTL).

### Example of a Method for Providing Video Clips Very Quickly

There is provided a Camera step (161), in which a camera or cameras represents any video source(s) which delivers a live feed, which passes on a live video feed to a video codec; the camera is for example a professional video camera with an SDI port, or a smartphone with a built-in camera, or a live e-Sports computer screen source. A video codec is an electronic circuit or software that compresses or decompresses digital video. It converts uncompressed video to a compressed format or vice versa. In the context of video compression, “codec” is a portmanteau of “enCODer” and “DECoder”.

There is provided a Live ingest step (162) to one or multiple resolutions, including reading in video feed(s) and creating multiple resolution video output files for editing and playback in an internet-friendly format; uploading such videos to the cloud or other publicly accessible internet servers.

There is provided an Edit step (163), in which a video editor system enables editing of video, audio, slides, titles and other media and metadata through the cloud or other internet servers, to provide one or more electronic Edit Decision Lists.

There is provided a Cloud hosting step (164), in which the electronic Edit Decision Lists (EDLs) of videos or other media edited in the Edit step above are saved in the cloud, or other publicly accessible servers, where the sources for the edited videos are already uploaded, or are uploading from step 162 above.

There is provided a Player view step (165), in which opening a browser or other software gives access to the edited videos by real time playback of the electronic EDLs saved in step 164 including: reading and interpreting the electronic EDL in step 164; downloading relevant video, audio, still, text and other files (including metadata files) from the Cloud in step 164 or the Live ingest computer(s) in step 162; combining the files to play back the edited video at any of the resolutions mentioned in relation to step 162; giving the viewer live controls over some combination of video resolution, image size, playback speed, position through jog and/or shuttle, keyboard short cuts and other controls.

In an example, video clips may be provided in less than 30 seconds from the original recording made using a video camera. In an example, video clips may be provided in less than 60 seconds from the original recording made using a video camera.

The method may be used to enable the viewing of video clips on mobile computing devices, on mobile phones, on smartphones, on tablet computers, on smart watches, on laptop computers, on desktop computers, and on smart TVs. The method may be used to enable the viewing of video clips using a web browser.

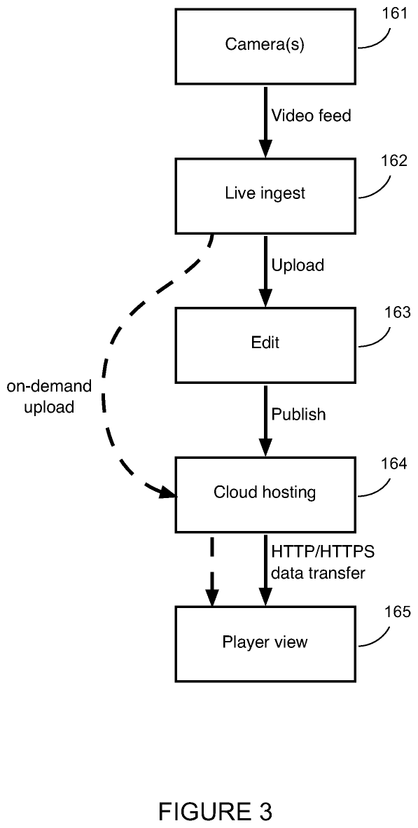

An example of the above method for providing video clips very quickly is provided in FIG. 3.

### Example of a System for Providing Video Clips Very Quickly

There is provided Loss free compression hardware and/or software (176). This is an optional system component for reducing the datarate of the compressed video output, eg. as output by step 162. The loss free compression system, such as Transition Tables (e.g. Forbidden Technologies' Transition Tables), an example of which is described in the “IMPROVEMENTS TO REPRESENTATIONS OF COMPRESSED VIDEO” section of this document, will typically have the following properties:
it must (or should) run quickly so that it can handle the volume of data in live video feeds;
it must (or should) not lock up for significant periods as the incoming live video stream will not wait for the compression;
it must (or should) be able to compress live feeds as they come in, rather than seeing a whole file in order to compress the data;

In addition, the corresponding decompression will typically include the following properties:
it must (or should) run quickly as the player may be real time;
it must not (or should not) lock up for noticeable periods of time as the video playback must be smooth;
it must not (or should not) generate significant quantities of garbage as garbage collectors in web languages such as JavaScript and Java can lock up for multiple video frames;
it must (or should) have a small enough executable to be downloaded in a web page before the video is played without causing inconvenience to the user;
it must (or should) have a small enough memory footprint to run in a browser.

There is provided Video/audio précis display hardware and/or software (177), which provides a visual summary of the video and/or audio, such as a navigation bar, which summarises the content at multiple scales and allows fast and convenient jog and/or shuttle navigation through an action such as mouse clicking or dragging on the display, as well as further uses such as rapid scene detection and (not detailed in this document, but as would be understood by one skilled in the art) detection of significant parts of the content by an artificial intelligence (AI) algorithm.

There is provided a Video codec hardware and/or software (178), including video compression/decompression hardware and/or software which allows the video to be compressed/decompressed, preferably with the following compression properties:
the compression should be able to handle live sources in real time, preferably at multiple resolutions;
the compressed video produced should be in a form which allows decompression of live feeds with low latency (for example, <5 seconds);
the video quality should be sufficiently high for end viewers;
the compression should preferably be fast enough to run in software on a standard device (e.g. a desktop computer);
the compression should support a range of resolutions;
the compression should create video which can be decompressed quickly from any point (eg. to support video editing and efficient navigation);
the compression should produce compressed video which allows multiple (but not necessarily all) temporal subsets to be accessed without reference to content not included in those temporal subsets;

The video codec will typically also have the following decompression properties:
the decompression must (or should) be efficient to allow real time playback;
it must (or should) be possible to synchronise the video and the audio tracks;
it must (or should) be possible to combine multiple video and audio tracks in. real time so electronic EDLs can be rendered during playback;
the decompression must (or should) be able to playback live feeds with low latency (e.g. <5 seconds);
the ability to play backwards and forwards at multiple speeds and at high displayed frame rate;
the decompression must not (or should not) create significant garbage while it is running, as garbage on typical web languages causes the software to lock up for the duration of multiple video frames.

There is provided an audio codec hardware and/or software (179), including audio compression/decompression hardware and/or software, which allows the audio to be compressed/decompressed, typically with the following compression properties:
the compression should be able to handle live sources in real time;
the audio quality should be sufficiently high for end viewers;
the compression should preferably be fast enough to run in software on a standard device (eg. a desktop computer);
the compression should support a range of qualities and audio sample rates;
the compression should produce compressed audio which can be decompressed from a live stream with low latency (eg. <2 s).

The audio codec will typically also have the following decompression properties:
the decompression must (or should) be efficient to allow real time playback;
the decompression must (or should) be able to decompress a live stream with low latency (eg. <2 seconds);
it must (or should) be possible to synchronise multiple audio tracks to any video tracks;
it must (or should) be possible to combine multiple video and audio tracks in real time so electronic EDLs can be rendered during playback;
the decompression must not (or should not) create significant garbage while it is running, as garbage on typical web languages causes the software to lock up for the duration of multiple video frames.

There is provided an Ingest system (1710), which is a system for taking in a video feed, typically with the following additional features:
video and audio is compressed in real time;
video is uploaded to a host cloud system through a network link;
the order which video and audio is uploaded is determined by an Upload ordering system (1711).

In addition, the Ingest may include:
an upload proxy;
a download proxy;
the creation of a multi-scale video and/or audio summary (177).
the ability to render electronic EDLs locally.

There is provided an Upload ordering system (1711), which is a system implementing a method of deciding which media data to upload, uploading as requested by another application, such as a video editor or video player, or as a result of a request by a connected cloud server, including as a result of a request from an application connected to the cloud, or as a result of a mirror method which makes copies of content on the cloud. Mirroring ordering typically includes:
uploading non-uploaded compressed audio, where available, as the highest priority;
uploading non-uploaded coarsest temporal resolution video frames as the next highest priority;
uploading the non-uploaded next-coarsest temporal resolution video frames as the next highest priority;
uploading in this fashion until all video and audio frames have been uploaded. In parallel, the mirror can request the upload of the précis (177).

There is provided a Download ordering system (1712), which enables applications using the video ingested by Ingest (1710) to request content. The download ordering provided includes:
frames of video and samples of audio which are required by an application to be displayed shortly;
when playing, frames ahead of the current play position which are expected to be displayed shortly;
when not playing, frames in the vicinity of the current play position which could be jogged or shuttled to shortly display, given the current resolution of the navigation tool, or frames which could be played back shortly if the video playback was to be started. In addition, a sprinkling of frames across the navigation bar are downloaded so nearby frames can be accessed quickly during shuttle. In one implementation, the frames are downloaded in chunks, each chunk being split into multiple files of video frames of decreasing temporal spacing, and multiple files are downloaded concurrently, with only one file from each chunk being downloaded at a time.

There is provided an Electronic EDL interpreter library hardware and/or software (1713) which allows electronic EDLs, and the sources they link to, to be converted into decompressed frames and audio samples, in real time for playback. It also allows random access to frames of video via a navigation bar, such as the précis (177). Where there is insufficient bandwidth to download all the content before it is required, the library returns a lower video frame rate. It also gives the option to select the video bitstream from a choice of video resolutions, altering the bandwidth requirements. It also includes an internal cache which contains compressed video and audio, as well as decompressed video frames and audio samples. It also renders electronic EDLs in real time, supporting multiple concurrent video and audio tracks. In the preferred implementation, it supports 12 video and 36 audio tracks.

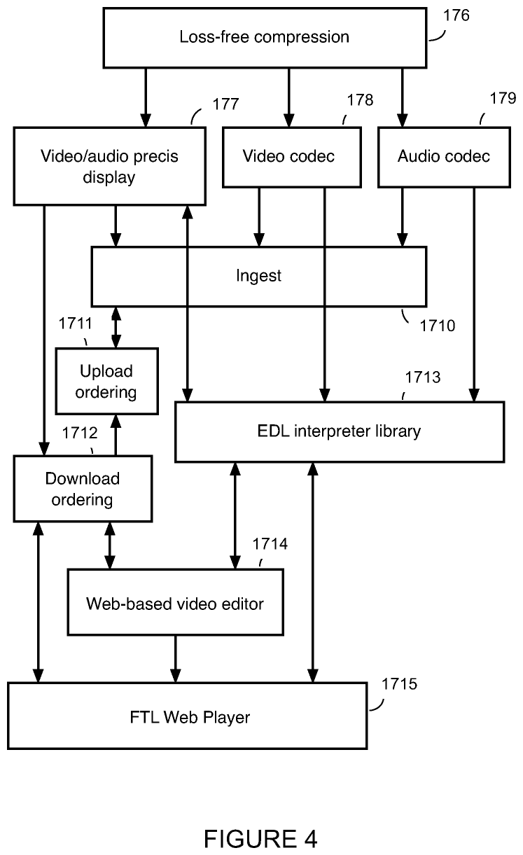

There is provided a Web-based video editor (1714): a video editor which runs in a web browser, or is launched from a web browser, which, in the preferred implementation, doesn't require configuration or installation of software written by a supplier of this technology. The editor should ideally be frame accurate, work in conjunction with the other components shown in FIG. 4 to improve performance, and it must support an option, which, very quickly (eg. in a fraction of a second), creates a cloud-hosted web page which can be accessed over a wide area network such as the internet and which contains a video player which plays back the published video.

There is provided a Web Player (1715), such as a JavaScript player (e.g. Blackbird's JavaScript player), in which the Web Player runs in a browser without configuration or installation, accessible to a wide audience, which allows playback of live and/or edited content, with a range of options which may include, amongst others:
a choice of video size;
a full-screen option;
jog at full video playback resolution;
shuttle at full video playback resolution;
playback at multiple speeds forwards and backwards;
a help screen;
support for keyboard short cuts;
an informative navigation bar, eg. (177);
playback of a quickly provided published video clip, as soon as it is published;
gradual degradation of experience where bandwidth is limited;
minimal delays for buffering;
internal caches for compressed and decompressed data;
ability to skip frames on playback where required;
ability to clip sections of Ingest (1710) videos and republish new web pages containing these subsets.

In an example, video clips may be provided in less than 30 seconds from the original recording made using a video camera. In an example, video clips may be provided in less than 60 seconds from the original recording made using a video camera.

The system may be used to enable the viewing of video clips on mobile computing devices, on mobile phones, on smartphones, on tablet computers, on smart watches, on laptop computers, on desktop computers, and on smart TVs. The system may be used to enable the viewing of video clips using a web browser.

An example of the above system for providing video clips very quickly is provided in FIG. 4. In FIG. 4, each arrow signifies “is used by”.

### FURTHER DISCLOSURES, WHICH MAY RELATE TO THE INVENTIONS OF THE PRESENT DOCUMENT

WO2018127695A2 discloses a method for encoding and decoding a video stream comprising dividing the video stream into a first Key frame, and subsequent chunks each comprising 2ⁿ frames, each chunk including a Key frame and 2ⁿ⁻¹ Delta (D^{x}) frames, where x is a positive integer and denotes the level of the Delta frame, and where 2^{x-1} denotes the number of Delta frames at that level in the chunk; the method including the step of constructing D^{x} level frames from adjacent Earlier and Later D^{y} frames, (where y<x and where for y=0, D^{y} is a Key frame), for all frames in a chunk where x>0; wherein the constructing step includes: dividing the frame into Motion Regions representing groups of pixels; determining a pixel group in an Earlier (E: D^{y}) and later (L: D^{y}) frame that is a best match for a pixel group in a Motion Region of a Current (C: D^{x}) frame; determining motion vectors for the best matches for Motion Regions, or by intra-frame compression of frame C. The method is characterised by eliminating unnecessary information when building a bitstream such that as x increases, motion vector and other data relating to a combination of D^{x} frames (more numerous than the D^{x-1} frames) is represented by a quantity of data in the bitstream that, for a typical video, increases at a much lower rate than the quantity of frames in D^{x} compared to the quantity of frames in D^{x-1}.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer-implemented method for tracking distribution of a shared digital media file, the method including the steps of:
(i) making a digital media file available at a server to a plurality of users, each user of the plurality of users having a respective registered account at the server;
(ii) receiving from a first user having a respective registered account at the server a request to share the digital media file with a second user having a respective registered account at the server;
(iii) sending a first link from the server to the second user, for accessing the digital media file, the first link including data uniquely identifying the digital media file, the first user and the second user;
(iv) the server receiving a selection of the first link by the second user;
(v) the server sending or playing the digital media file to the second user;
(vi) the server recording that the digital media file was shared by the first user with the second user, to track distribution of the digital media file.

2. The method of claim 1, wherein the first link is a Uniform Resource Locator (URL).

3. The method of claim 1, wherein the digital media file is a digital video file, or a digital image file or a digital audio file.

4. The method of claim 1, wherein step (ii) includes using a first user web-based media player including a respective web-based media player user interface, and steps (iii), (iv) and (v) include using a second user web-based media player including a respective web-based media player user interface.

5. The method of claim 4, wherein the web-based media players provide sharing of the digital media file, without requiring re-rendering.

6. The method of claim 4, wherein the web-based media players permit clipping content prior to sharing clipped content of the digital media file.

7. The method of claim 4, wherein the web-based media players permit clipping content prior to sharing clipped content of the digital media file, without requiring re-rendering.

8. The method of claim 4, wherein the web-based media players permit re-clipping content prior to sharing re-clipped content of the digital media file, or wherein the web-based media players permit re-clipping content prior to sharing re-clipped content of the digital media file, without requiring re-rendering.

9. (canceled)

10. The method of claim 4, wherein the web-based media players user interfaces include buttons selectable to select a monetary value, or wherein the web-based media players user interfaces include buttons selectable to select player features such as play the digital media file on a full screen; play the digital media file in a window; change video playback size; change video playback resolution; share the digital media file or share a clip of the digital media file.

11. (canceled)

12. The method of claim 4, wherein the web-based media players user interfaces include navigation controls and/or playback controls, or wherein the web-based media players user interfaces include buttons for playback at various speeds backwards and forwards. marking start and end points of clips (which may alternatively be achieved via interaction with the video area), single step (or larger jumps) backwards and forwards, jog and shuttle on a navigation bar.

13. (canceled)

14. The method of claim 4, wherein the web-based media players user interfaces run in JavaScript in a respective web browser, or wherein the web-based media players user interfaces include one or more of: frame accurate access, a choice of playback speeds backwards and forwards, jog and shuttle, a choice of frame size and resolution, including full screen, as well as clipping options, sharing options and payment options.

15. (canceled)

16. The method of claim 1, wherein all sharing selected through the web-based media players user interfaces is recorded at the server.

17. The method of any previous claim 1, wherein the rights and payment metadata associated with each digital media file are represented by a unique random string attached to the URL.

18. The method of claim 17, wherein the unique random string is used as a key in a key: value dictionary, where the value contains all the information required to track rights, for example, the ids of the Creator and all subsequent rights holders, the share of income rights purchased by each rights holder, the date of expiry of any rights.

19. The method of claim 1, (a) wherein the server supports a payment system, such as Stripe or direct credit card receipts, to allow money to be credited to the accounts of individual users, for example if they have insufficient funds to contribute the amount on a button they pushed; or
(b) wherein each time a new digital media file is published, its metadata contains one or more financial values, which are assigned to buttons displayed in the web-based media player user interface; or
(c) wherein each time a new digital media file is published, its metadata contains one or more financial values, which are assigned to buttons displayed in the web-based media player user interface, and wherein each time someone clicks on one of these buttons, money or tokens representing value are deducted from the viewer's account and assigned to the accounts of the people along the distribution chain, including to the account of the original Creator, and to the server provider itself.

20-24. (canceled)

25. The method of claim 1, (a) wherein the server allows a content Creator to set a player configuration, which includes the option of one or more payment buttons; or
(b) wherein every time a payment is made by a viewer, the content Creator receives a share of this payment; or
(c) wherein the content creator receives a share of any payments received on re-shared or clipped and shared media derived from the content creator's original work; or
(d) wherein the content creator receives a share of any payments received on re-shared or clipped and shared media derived from the content creator's original work, and in which the receipts match the proportion of income received from payments for the original video.

26-28. (canceled)

29. The method of claim 1, wherein step (vi) is performed, without using a blockchain.

30. The method of claim 1, wherein step (vi) is performed, by storing the first link including the data uniquely identifying the digital media file, the first user and the second user, or wherein in step (iii) the data uniquely identifying the digital media file, the first user and the second user is encrypted, and wherein in step (iv) the encrypted data uniquely identifying the digital media file, the first user and the second user is decrypted.

31-62. (canceled)

63. The method of claim 1, wherein the digital media file is a digital video file and the digital video file is converted into a compressed format structure, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy.

64. The method of claim 63, including the further steps of: receiving an electronic edit decision list which defines how to manipulate the compressed format structure;
saving the electronic edit decision list;
receiving a request to provide in a web browser executing on a user terminal a video clip playback corresponding to a video clip defined by the compressed format structure and the electronic edit decision list;
sending to the web browser code executable in the web browser to provide the video clip playback corresponding to the video clip defined by the compressed format structure and the electronic edit decision list, and
responding to requests from the code when executing in the web browser, to provide content corresponding to the compressed format structure, in accordance with the electronic edit decision list, to the web browser, to provide the video clip playback.

65. (canceled)

66. A server configured to track distribution of a shared digital media file, the server configured to:
(i) make a digital media file available to a plurality of users, each user of the plurality of users having a respective registered account at the server;
(ii) receive from a first user having a respective registered account at the server a request to share the digital media file with a second user having a respective registered account at the server;
(iii) send a first link to the second user, for accessing the digital media file, the first link including data uniquely identifying the digital media file, the first user and the second user;
(iv) receive a selection of the first link by the second user;
(v) send or play the digital media file to the second user;
(vi) record that the digital media file was shared by the first user with the second user, to track distribution of the digital media file.

67. (canceled)

68. A system including a first user terminal, a second user terminal, and a server configured to track distribution of a shared digital media file, wherein:
(i) the server is configured to make a digital media file available to a plurality of user terminals, each user of the plurality of user terminals having a respective registered account at the server;
(ii) the server is configured to receive from a first user using the first user terminal, and having a respective registered account at the server, a request to share the digital media file with a second user using the second user terminal, and having a respective registered account at the server;
(iii) the server is configured to send a first link to the second user terminal, for accessing the digital media file, the first link including data uniquely identifying the digital media file, the first user and the second user;
(iv) the server is configured to receive a selection of the first link by the second user using the second user terminal;
(v) the server is configured to send or to play the digital media file to the second user terminal;
(vi) the server is configured to record that the digital media file was shared by the first user with the second user, to track distribution of the digital media file.

69-83. (canceled)
